(19) United States
(12) Patent Application Publication
(10) Pub. No.: US 2023/0291511 A1
(43) Pub. Date: Sep. 14, 2023

(54) Method and Apparatus for Multi-Dimensional Complex-Valued Sample Encoding and Decoding

(71) Applicants: Ramesh Annavajjala, Natick, MA (US); Kuntal Chowdhury, Andover, MA (US)

(72) Inventors: Ramesh Annavajjala, Natick, MA (US); Kuntal Chowdhury, Andover, MA (US)

(21) Appl. No.: 17/691,663

(22) Filed: Mar. 10, 2022

(51) Int. Cl. H04L 5/00; G01S 13/04

(52) U.S. Cl. CPC H04L 5/0023; G01S 13/04

(57) ABSTRACT

Complex-valued waveform samples in time-domain, frequency-domain and spatial-domain are organized into a plurality of dimensions. A vector of complex-valued samples is extracted from a multidimensional sample buffer. An input transform is applied to a vector of complex-valued samples to produce two vectors of real-valued samples. Each real-valued sample vector is processed to produce a two-dimensional codebook matrix and to generate a vector of indices into the columns of the generated codebook. The two indices vectors are merged to produce an encoded index stream. The encoded index stream along with the two codebooks is used to produce real-valued sample vectors. An output transform is applied to two real-valued sample vectors to produce a vector of complex-valued samples.

### DETAILED DESCRIPTION OF THE INVENTION

The embodiments of our invention provide methods for encoding and decoding of complex-valued sample data stored in a plurality of dimensions.

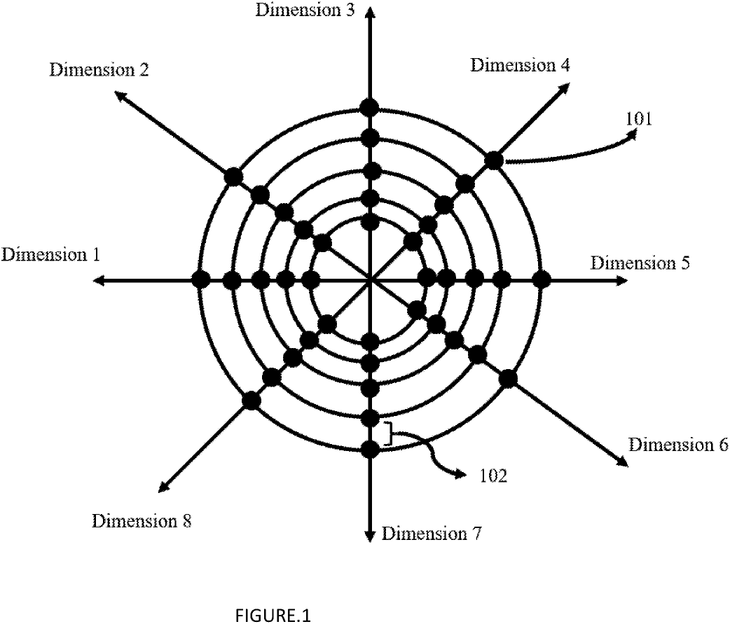

FIG. 1 shows the representation of complex-valued sample data over eight dimensions including a complex-valued sample on one of the dimensions 101 and the sample spacing on one of the dimensions 102 according to the embodiments of our invention.

While FIG. 1 depicts 8 dimensions, it is to be understood that a similar depiction accommodates an arbitrary number of dimensions. With K dimensions, the number of samples present in dimension k is N[k], k=1, 2,..,K, and the total number of samples present in K dimensions is Ntotal which is equal to the product of the number of samples present in each dimension. That is, Ntotal = N[1]*N[2]*...*N[K]. The spacing of samples 102 can be equal or unequal across the samples in a given dimension. The spacing of samples 102 can be identical or non-identical across the dimensions. One sample in a K dimensional sample buffer is indexed using a K dimensional index vector (I[1],I[2],..,1[K]) where 1<= I[1] <= N[1], 1<= I[2] <= N[2],..., and 1 <= I[K] <= N[K] when all the indices start from 1.

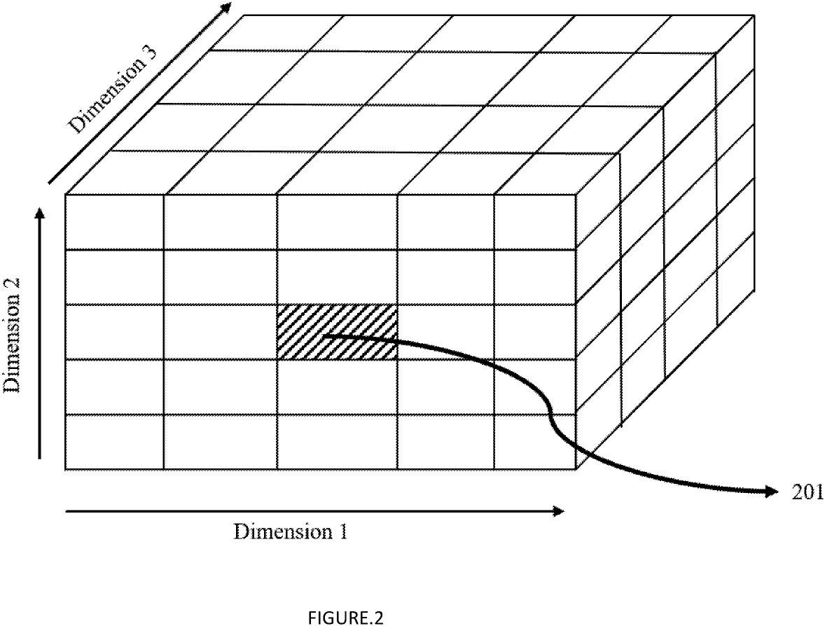

FIG. 2 shows organization of sample data over three dimensions including a sample 201 indexed by its location in each of the three dimensions according to the embodiments of our invention.

The number of samples in the first dimension is N[1], the number of samples in the second dimension is N[2], and the number of samples in the third dimension is N[3]. The total number of samples present in the three-dimensional data volume is N[1]*N[2]*N[3]. With (I[1],I[2],I[3]) denoting the 3-dimensional indices, and with D denoting the 3-dimensional sample buffer, sample 201 is given by D(I[1],l[2],I[3]).

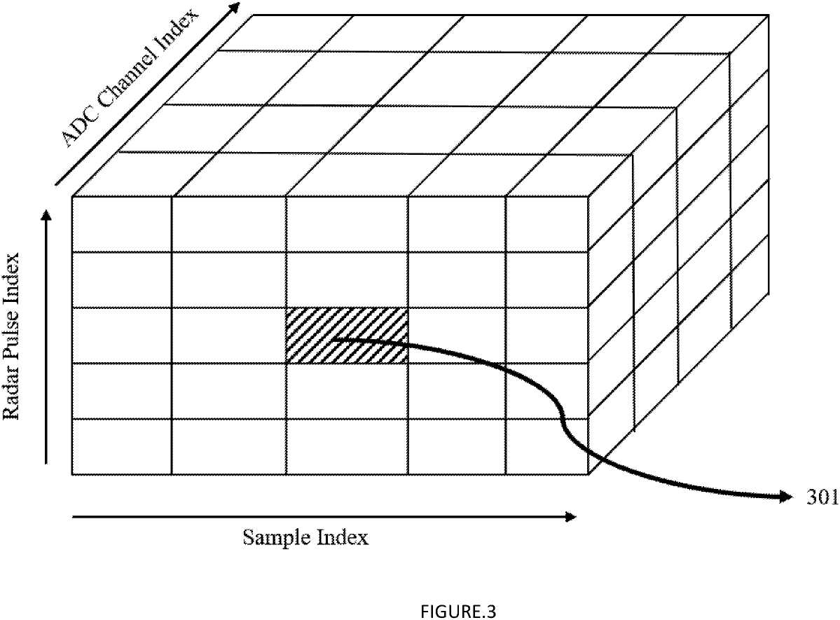

FIG. 3 shows the representation of complex-valued radar returns in three dimensions including the radar sample return 301 indexed by the sample position on a given radar return pulse, an index of the transmitted pulse, and an index of the ADC channel according to the embodiments of our invention.

A Radar sensor transmits pulses and the pulse returns, or echoes, are processed to detect the presence of targets. Each received pulse is sampled at a particular sampling frequency that can be configurable by the radar sensor. With NS denoting the number of samples per pulse and Fs denoting the sample frequency, the pulse duration T is given by T = NS/Fs. Each pulse is received simultaneously by ND data converters. With K pulses in a radar frame, the number of samples in the radar buffer is: NS*K*ND which is placed in a 3-dimensional buffer D with N[1] = NS, N[2] = K, and N[3] = ND. One sample 301 in the radar buffer is indexed by D(I(1),I(2),I(3)) where I(1) is the index of the sample in a radar pulse, I(2) is the pulse index, and I(3) is the index of the ADC channel.

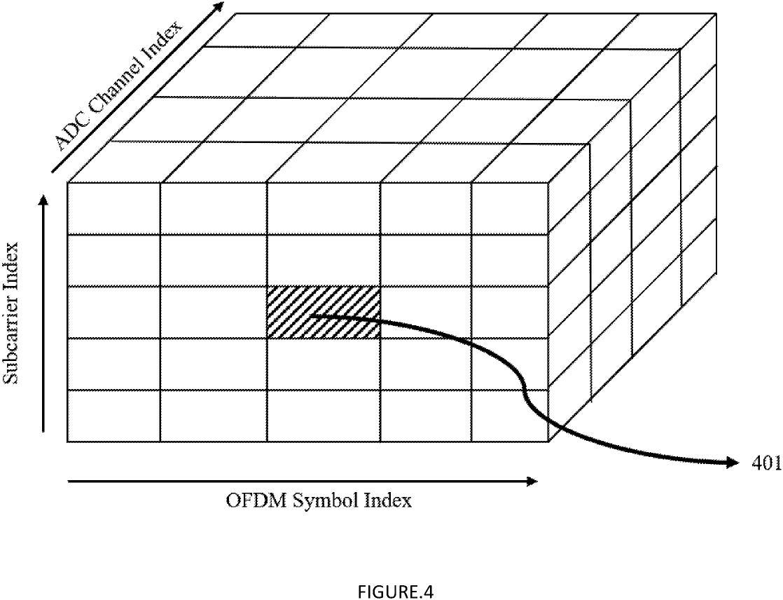

FIG. 4 shows the representation of complex-valued received baseband samples in a MIMO-OFDM wireless system in three dimensions including the baseband sample 401 indexed by the OFDM symbol index, subcarrier index, and the ADC channel index according to the embodiments of our invention.

In a MIMO-OFDM wireless system, OFDM waveforms are transmitted from each transmitter antenna port. Each OFDM symbol of NF samples is constructed by performing an NF-point inverse fast-Fourier transform (FFT) on a vector of NF-length frequency-domain modulation symbols. Optionally, a cyclic prefix of length NCP samples is added to each OFDM symbol to account for channel delay spread. At the transmitter, with NS OFDM symbols in a frame, NF modulation symbols per OFDM symbol, and NT transmit antenna ports, the available modulation symbols are stored in a 3-dimensional grid D of size N[1] = NS, N[2] = NF and N[3] = NT. One frequency-domain modulation symbol at the transmitter is indexed by D(I(1), I(2), I(3)) where 1<=l(1) <= N[1], 1 <= l(2) <= N[2], and 1 <= I(3) <= N[3] when all the indices start from 1.

At the receiver, an OFDM symbol is received over NR antenna ports. Upon performing ADC on each antenna port, extracting the cyclic prefix if present, and performing an NF-point FFT, each receive antenna port collects NF complex-valued samples. With NS OFDM symbols, NF samples per OFDM symbol, and NR ADC channels, the received samples are stored in a 3-dimensional grid D of size N[1] = NS, N[2] = NF and N[3] = NR. One frequency-domain received sample is indexed by D(I(1), I(2), I(3)) where 1<=I(1) <= N[1], 1 <=I(2) <= N[2], and 1 <=I(3) <= N[3] when all the indices start from 1.

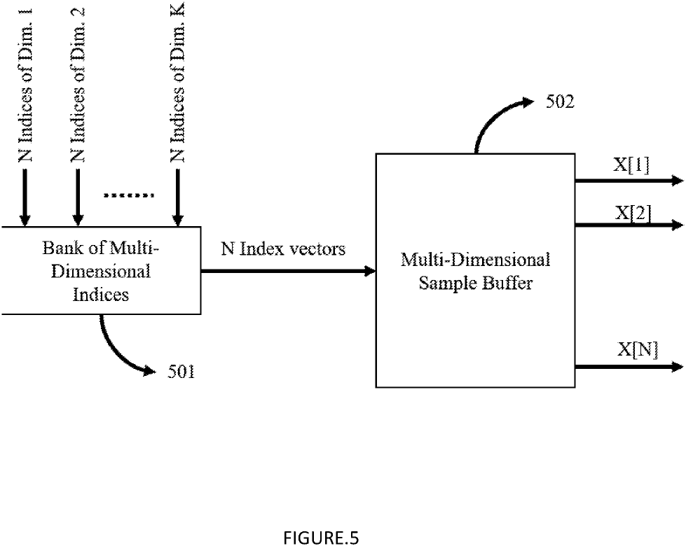

FIG. 5 shows the extraction of a block of samples from a multi-dimensional sample buffer including a bank of multi-dimensional indices 501 and a multi-dimensional sample buffer 502 according to the embodiments of our invention.

For a K-dimensional sample buffer D, the number of samples in the k-th dimension are N[k] so that the total number of samples in the K-dimensional sample buffer are Ntotal = N[1]*N[2]*...*N[K]. A vector of N complex-valued samples (X[1],X[2],...,X[N]) are to be extracted from a K dimensional sample buffer 501 with N[k] elements in dimension k.

For dimension k, a vector of N indices is given by (l(k,1),I(k,2),..,I(k,N)). Vectors (I(1,1),I(1,2),..,l(1,N)), (1(2,1),1(2,2),..,1(2,N)),..., (I(K,1),I(K,2),..,I(K,N)) are processed by 501 to produce N index vectors (j[1,1],j[2,1],...,j[K,1]), (j[1,2],j[2,2],...,j[K,2]), ..., (j[1,N],j[2,N],...,j[K,N]) where j[m,n] is the location of sample X[n] in dimension m.

With (j[1,n], j[2,n],..,j[K,n]) as one K-dimensional index vector, 502 produces complex-valued samples X[n] using the assignment X[n] = D(j[1,n],j[2,n],...,j[K,n]) for n=1,...,N.

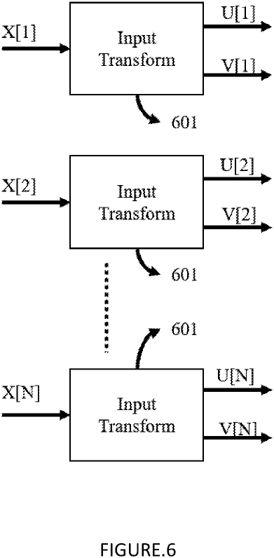

FIG. 6 shows the input transform operation performed over a vector of complex-valued samples including the input transform 601 according to the embodiments of our invention.

The vector of samples is denoted by (X[1], X[2],...,X[N]) where N is the number of samples in the vector. Each sample X[i], i=1,...,N, is complex-valued. The real part of X[i] is denoted by Re(X[i]) and the imaginary part of X[i] is denoted by Im(X[i]).

In one configuration, 601 processes a complex-valued sample X to produce two real-valued samples U and V with U = Re(X) and V = Im(X).

In one configuration, 601 processes a complex-valued sample X to produce two real-valued samples U and V with U = Re(X) + Im(X) and V = Re(X)-Im(X).

In one configuration, 601 processes a complex-valued sample X to produce two real-valued samples U and V with U = SQRT(Re(X)*Re(X) + Im(X)*lm(X)) and V = ATAN(Im(X)/Re(X)) where SQRT is the mathematical square-root operation and ATAN is the mathematical inverse tangent operation.

In one configuration, 601 processes a complex-valued sample X to produce two real-valued samples U and V with U = LOG(SQRT(Re(X)*Re(X) + Im(X)*lm(X))) and V = ATAN(Im(X)/Re(X)) where LOG is the mathematical natural logarithmic operation.

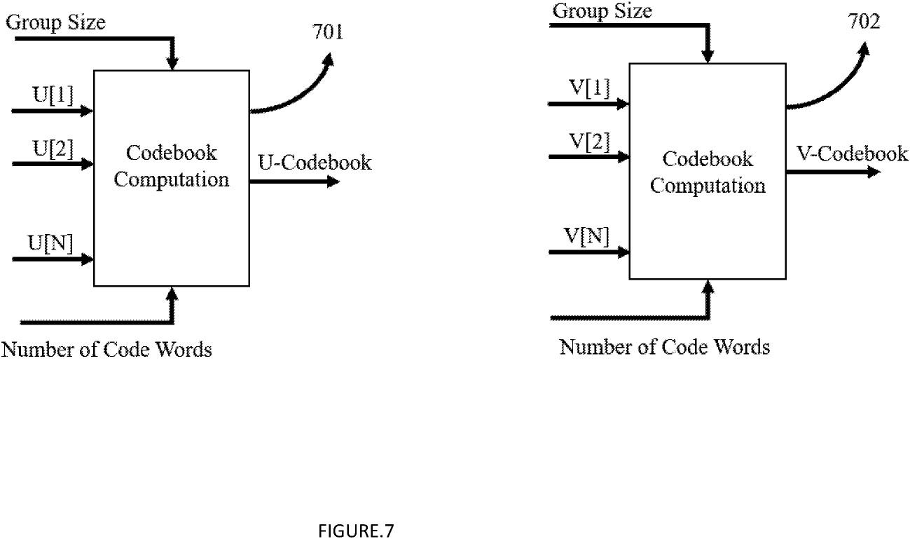

FIG. 7 shows the codebook computation operation over a vector of real-valued samples including U-vector codebook computation 701 and V-vector codebook computation 702 according to the embodiments of our invention.

Group size is the number of samples to process simultaneously to generate one code word. With a group size equal to P as input to 701, and an input vector (U[1],U[2],...,U[N]) of length N, a single code word is generated using samples U[k], U[k+1],..., U[k+P-1]. When N is a multiple of P, a total of N/P code words are associated with the N-length vector (U[1],U[2],...,U[N]). When the number of code words is set to LP as an input to 701, the U-Codebook produced by 701 is a two-dimensional matrix of P rows and LP columns. In a similar manner, with Group Size = Q and Number of Code Words = LQ as inputs to 702, the V-Codebook produced by 702 is a two-dimensional matrix of Q rows and LQ columns.

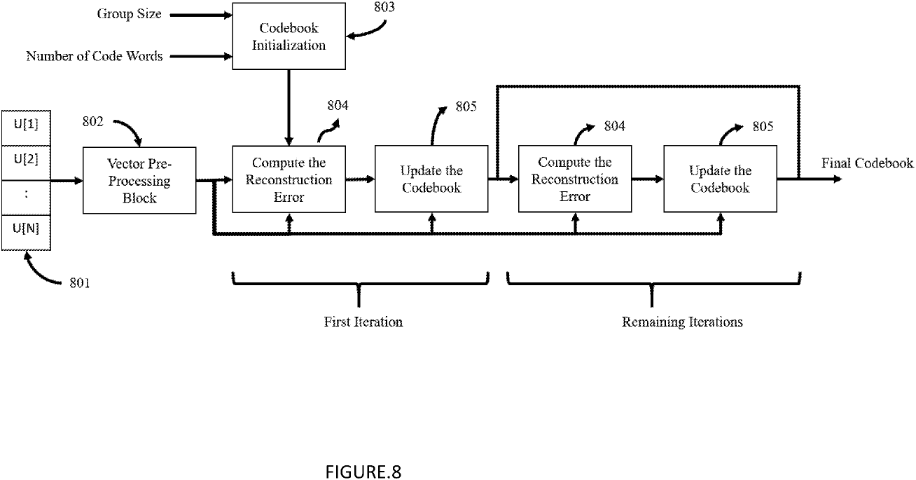

FIG. 8 shows the final codebook generation process starting with a vector of real-valued samples including the U-vector sample buffer 801, vector pre-processing block 802, codebook initialization 803, reconstruction error computation 804, and codebook update 805 according to the embodiments of our invention.

A block of N samples 801 are pre-processed by 802. Pre-processing steps include mean removal, sample decorrelation, and standardization of each sample to limit the values taken by a sample.

Codebook initialization 803 takes a group size P and a number of code words LP to generate a random initial codebook of size P rows and LP columns. Each element of the initial codebook has values drawn from a probability distribution. Example probability distributions include multi-variate Gaussian distribution and multi-variate Laplacian distribution.

A number of iterations are set to complete the final codebook generation process. In the first iteration, a vector of reconstruction error values is computed 804 using the initial codebook of size P-by-LP. The samples after the vector pre-processing block are grouped into N/P blocks with each block having P samples. Block b has a sample vector (U[b*P+ 1], U[b*P+2],...,U[b*P+P]), where b = 0,1,2,..,(N/P)-1. For each block b, LP squared Euclidean distances are computed, where the I-th distance is between the P samples of block b and the P samples of column I of the codebook. The distance between block b and column I of the codebook is denoted by DIST(b, I), b = 0,1,..,(N/P)-1 and I= 1,2,..,LP. For each I, the median of (N/P) distances DIST(0, I),.., DIST((N/P)-1, I) is computed and is stored in MedDIST(I).

Using the distance vector (MedDIST(1),...,MedDIST(LP)) and the pre-processed input from 802, codebook update in the first iteration 805 is done by employing clustering algorithms as described in [Reference: R. O. Duda, P. E. Hart and D. G. Stork, “Pattern Classification” 2^{nd} Edition, Wiley-Intercience, 2000] and [Reference: Gersho, A. and R. Gray, “Vector Quantization and Signal Compression,” Boston, Kluwer Academic Publishers, 1992.].

The codebook update is refined over the remaining iterations using previously computed codebooks, previously updated median distance vectors, and the pre-processed inputs to produce a final codebook of size P-by-LP.

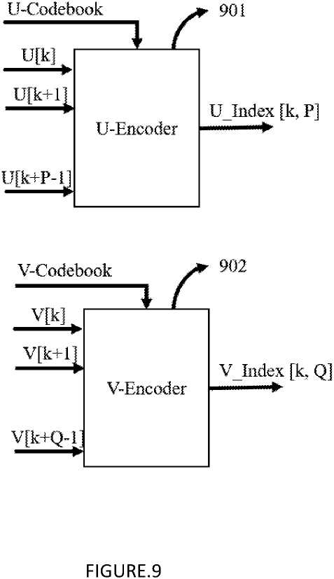

FIG. 9 shows the generation of an index based on a vector of real-valued samples and a codebook including the U-vector index generation 901 and V-vector index generation 902 according to the embodiments of our invention.

U-Codebook is a matrix of real-valued entries with P rows and LP columns. U-Codebook[i,j] denotes the i-th row and j-th column element of U-Codebook.

V-Codebook is a matrix of real-valued entries with Q rows and LQ columns. V-Codebook[i,j] denotes the i-th row and j-th column element of V-Codebook.

Generation of U_Index[k,P] requires LP metrics computations. The LP metrics are MetricP(1),MetricP(2),...,MetricP(LP). MetricP(n) is the Euclidean distance between the P-dimensional vector (U[k],U[k+1],...,U[k+P-1]) and the P-dimensional vector in column n of U-Codebook.

U_Index[k,P] is the index of the smallest of LP metrics MetricP(1), MetricP(2), ..., MetricP(LP). U_Index[k,P] is represented in a binary string of length CEIL(log2(LP)) where CEIL is the mathematical ceiling operation.

Generation of V_Index[k,Q] requires LQ metrics computations. The LQ metrics are MetricQ(1),MetricQ(2),...,MetricQ(LQ). MetricQ(n) is the Euclidean distance between the Q-dimensional vector (V[k],V[k+1],...,V[k+Q-1]) and the Q-dimensional vector in column n of V-Codebook.

V_Index[k,Q] is the index of the smallest of MetricQ(1),MetricQ(2),...,MetricQ(LQ). V_Index[k,Q] is represented in a binary string of length CEIL(log2(LQ)) where CEIL is the mathematical ceiling operation.

Generated U_Index and V_Index bit streams are grouped into a single bit stream and transmitted to a remote processor where these bit streams are decoded to produce U_hat and V_hat. Codebooks U_Codebook and V_Codebook are converted into bit streams by representing each element in the codebook using a predefined number of bits, and the bit streams of U_Codebook and V_Codebook are also transmitted to the remote processor to decode U_Index and V_Index. Additionally, input transform configuration, group sizes, number of codewords information are also transmitted to the remote processor either in a static one-time configuration or in a configuration that can be dynamically negotiated with the remote processor over a management interface.

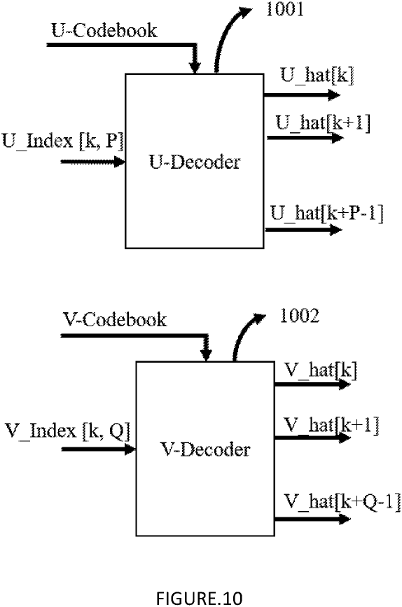

FIG. 10 shows the generation of a vector of real-valued samples based on an index and a codebook including the U-vector generation using the U-Decoder 1001 and V-vector generation using the V-Decoder 1002 according to the embodiments of our invention.

U-Codebook is a matrix of real-valued entries with P rows and LP columns. U-Codebook[i,j] denotes the i-th row and j-th column element of U-Codebook.

V-Codebook is a matrix of real-valued entries with Q rows and LQ columns. V-Codebook[i,j] denotes the i-th row and j-th column element of V-Codebook.

U_Index[k,P] is an integer within 1 and LP or a binary string of length CEIL(log2(NP)).

V_Index[k,Q] is an integer within 1 and LQ or a binary string of length CEIL(log2(NQ)).

U-Decoder 1001 produces (U_hat[k],U_hat[k+1],...,U_hat[k+P-1]) with U_hat[j] = U-Codebook[j-k+1,U_Index[k,P]] for j=k, k+1,..., k+P-1.

V-Decoder 1002 produces (V_hat[k],V_hat[k+1],...,V_hat[k+Q-1]) with V_hat[j] = V-Codebook[j-k+1,V_Index[k,Q]] for j=k, k+1,..., k+Q-1.

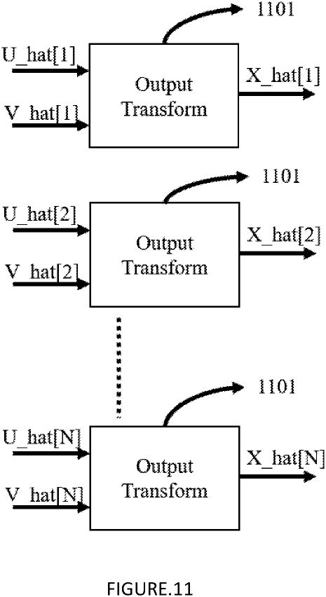

FIG. 11 shows the output transform operation performed over a vector of real-valued samples including the output transform 1101 according to the embodiments of our invention.

From two real-valued vectors (U_hat[1],U_hat[2],...,U_hat[N]) and (V_hat[1],V_hat[2],...,V_hat[N]), where N is the number of samples in each vector, N pairs are created with (U_hat[i], V_hat[i]) denoting the i-th pair.

In one configuration, 1101 processes a pair of real-valued samples (U_hat, V_hat) to produce one complex-valued sample X_hat with X_hat = COMPLEX(U_hat, V_hat) where COMPLEX(u, v) is a complex number whose real part is u and whose imaginary part is v.

In one configuration, 1101 processes a pair of real-valued samples (U_hat, V_hat) to produce one complex-valued sample X_hat with X_hat = COMPLEX(U_hat*COSINE(V_hat),U_hat*SINE(V_hat)) where COSINE is the trigonometric cosine operation and SINE is the trigonometric sin operation.

In one configuration, 1101 processes a pair of real-valued samples (U_hat, V_hat) to produce one complex-valued sample X_hat with X_hat = COMPLEX(EXP(U_hat)*COSINE(V_hat),EXP(U_hat)*SINE(V_hat)) where EXP is the mathematical exponential operation.

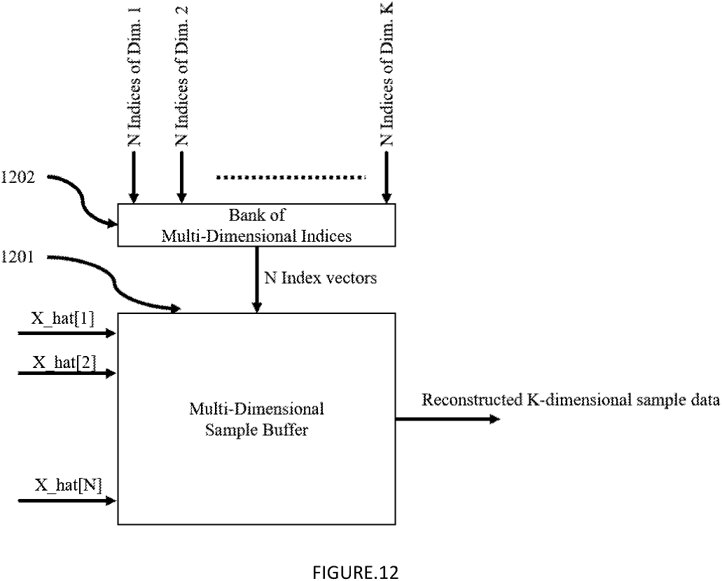

FIG. 12 shows the reconstruction of a multi-dimensional sample buffer based on a vector of reconstructed complex-valued samples including a bank of multi-dimensional indices 1201 and a multi-dimensional sample reconstruction buffer 1202 according to the embodiments of our invention.

For a K-dimensional sample buffer, the number of samples in the k-th dimension are N[k] so that the total number of samples in the K-dimensional sample buffer are Ntotal = N[1]*N[2]*...*N[K]. A vector of N complex-valued samples (X_hat[1],X_hat[2],...,X_hat[N]) are to be stored in a K-dimensional sample buffer 1201 with N[k] elements in dimension k.

For dimension k, a vector of N indices is given by (l(k,1),I(k,2),..,I(k,N)). Vectors (I(1,1),I(1,2),..,l(1,N)), (l(2,1),l(2,2),..,l(2,N)),..., (I(K,1),I(K,2),..,I(K,N)) are processed by 1202 to produce N index vectors (j[1,1],j[2,1],...,j[K,1]), (j[1,2],j[2,2],...,j[K,2]), ..., (j[1,N],j[2,N],...,j[K,N]) where j[m,n] is the location of sample X_hat[n] in dimension m.

Reconstructed K-dimensional complex-valued buffer D has Ntotal samples with N[k] denoting the number of samples in dimension k. Sample X_hat[n] is placed at index j[k,n] in the k-th dimension with k=1,..,K with the assignment D(j[1,n],j[2,n],...,j[K,n]) = X_hat[n], n=1,..,N.

1. A method for storing and retrieving a plurality of complex-valued samples in a sample buffer organized into a plurality of dimensions, comprising:
The complex-valued sample data with three dimensions wherein the first dimension is the number of samples per pulse, the second dimension is the number of pulses, and the third dimension is the number of antenna channels; and
The complex-valued sample data with three dimensions wherein the first dimension is the number of subcarriers per OFDM symbol, the second dimension is the number of OFDM symbols, and the third dimension is the number of antenna channels.

2. The method of claim 1, wherein an input transform is applied on the plurality of complex-valued samples further comprising:
The input transform on a complex-valued input sample produces amplitude and phase of the input sample; and
The input transform on a complex-valued input sample produces real-part and imaginary-part of the input sample; and
The input transform on a complex-valued input sample produces sum of the real-part and imaginary-part and difference of the real-part and imaginary-part of the input sample; and
The input transform on a complex-valued input sample produces logarithm of the amplitude and phase of the input sample.

3. The method of claim 2, wherein codebooks are generated from a plurality of real-valued samples further comprising:
Generation of a column index from a two-dimensional matrix of real-valued entries organized into rows and columns and a plurality of real-valued samples.

4. A method of transmission of codebooks and the indices to a remote processor, consisting of two codebooks (U-Codebook, V-Codebook), two vector-valued indices into the codebooks (U_Index, V_Index).

5. The method of receiving and storing the two codebooks and the two vector-valued indices in a buffer at the remote processor.

6. The method of claim 5, wherein an output transform is applied on the plurality of real-valued samples further comprising:
The output transform on two real-valued input samples produces a complex-valued sample with real-part is equal to the first input sample and imaginary-part equal to the second input sample; and
The output transform on two real-valued input samples produces a complex-valued sample with real-part is equal to the product of the first input sample and the cosine of the second input and imaginary-part equal to the product of the first input sample and the sine of the second input; and
The output transform on two real-valued input samples produces a complex-valued sample with real-part is equal to the product of the exponential of the first input sample and the cosine of the second input and imaginary-part equal to the product of the exponential of the first input sample and the sine of the second input sample.
